(19) United States
(12) Patent Application Publication
(10) Pub. No.: US 2014/0146734 A1
(43) Pub. Date: May 29, 2014

(54) SYSTEMS AND METHODS FOR POWER CONSERVATION IN WIRELESS NETWORKS

(71) Applicant: QUALCOMM INCORPORATED, San Diego, CA (US)

(72) Inventor: Sanjay Katabathuni, San Jose, CA (US)

(73) Assignee: QUALCOMM Incorporated, San Diego, CA (US)

(21) Appl. No.: 13/685,247

(22) Filed: Nov. 26, 2012

(51) Int. Cl. H04W 52/02

(52) U.S. Cl. CPC H04W 52/02
USPC 370/312

(57) ABSTRACT

Systems and methods are disclosed that are directed to an access point for supporting multiple basic service sets (BSSs), such that the access point is configured to transmit an uninterrupted sequence of beacons for each of the BSSs followed by one or more groups of multicast frames. In one aspect, the access point may send multicast frames for each of the BSSs after the sequence of beacons. In another aspect, the access point may send multicast frames for one of the BSSs after a first sequence of beacons and send multicast frames for other BSSs after subsequent sequences of beacons.

### FIELD OF THE PRESENT INVENTION

This disclosure generally relates to wireless communication systems and more specifically to systems and methods for conserving power while coordinating operation of multiple service sets.

### BACKGROUND OF THE INVENTION

Wireless networks are increasingly employed to provide various communication functions including voice, video, packet data, messaging and the like. A common example of wireless local area network (WLAN) architecture is an infrastructure network adhering to 802.11 standards established by the Institute of Electrical and Electronics Engineers (IEEE) that typically employ one or more access points to coordinate communications for a number of stations or other client devices. In an infrastructure network, the access point and associated stations may be known as a basic service set (BSS).

Due to the wide availability, popularity and convenience of WLAN-based wireless communications, it may be desirable for a single access point to manage multiple, independent BSSs. By providing multiple BSSs, a service provider may offer different levels of service or different network capabilities. For example, each BSS may offer a different quality of service (QoS), such that one BSS may be tailored for high throughput, low latency applications including voice or video communication and multimedia streaming while another BSS may offer lower throughput for less demanding applications. Further, the use of multiple BSSs also allows for different degrees of security or provides different levels of access to network resources.

Although such BSSs may be provided through the use of separate, independent access points, various economies may be achieved through the use of a single access point capable of supporting the multiple basic service sets. In addition, particularly for BSSs serving mobile client devices and other stations subject to power availability constraints, it would be desirable to manage multiple BSSs in a manner that enables any associated devices to save power. Accordingly, there is a need for systems and methods for supporting multiple BSSs with a single access point while offering improved power efficiency. This invention satisfies this and other needs.

### SUMMARY OF THE INVENTION

In accordance with the above needs and those that will be mentioned and will become apparent below, this specification discloses methods for wireless communication in a system including a plurality of independent basic service sets (BSSs), involving the steps of buffering multicast data for the plurality of BSSs, transmitting a first uninterrupted sequence of beacons comprising one beacon for each of the BSSs, and transmitting pending multicast data for a first BSS of the plurality of BSSs following the first sequence of beacons. In one aspect, pending multicast data may be transmitted for the BSSs following the first sequence of beacons. In another aspect, such methods may further include the steps of transmitting a second uninterrupted sequence of beacons comprising one beacon for each of the BSSs and transmitting pending multicast data for a second BSS of the plurality of BSSs following the second sequence of beacons.

In some embodiments, transmitting the first uninterrupted sequence of beacons may include transmitting a beacon including a delivery traffic indication map (DTIM) information element configured to signal whether pending multicast data will be transmitted to a BSS associated with the beacon following the first sequence of beacons.

As desired, transmitting pending multicast data may include transmitting pending multicast data in an order determined using a round robin schedule or using a weighted schedule.

This disclosure is also directed to systems for wireless communication including an access point that supports a plurality of independent basic service sets (BSSs), wherein the access point has a wireless local area (WLAN) module configured to transmit a first uninterrupted sequence of beacons comprising one beacon for each of the BSSs and a scheduler configured to transmit pending multicast data for a first BSS of the BSSs following the first sequence of beacons. In one aspect, the scheduler may transmit a second uninterrupted sequence of beacons comprising one beacon for each of the BSSs and transmit pending multicast data for a second BSS of the plurality of BSSs following the second sequence of beacons. The scheduler may be configured to transmit pending multicast data for the BSSs following the first sequence of beacons.

In one aspect, the first sequence of beacons may include a beacon including a delivery traffic indication map (DTIM) information element to signal whether pending multicast data will be transmitted to a BSS associated with the beacon following the first sequence of beacons.

In another aspect, the scheduler may be configured to deliver pending multicast data in an order determined using a round robin schedule or using a weighted schedule.

This disclosure is also directed to a non-transitory processor-readable storage medium for managing communication in a power save mode of a wireless local area network (WLAN) having a plurality of independent basic service sets (BSSs), the processor readable storage medium having instructions thereon which include code for causing an access point to buffer multicast data for the plurality of BSSs, code for causing the access point to transmit a first uninterrupted sequence of beacons comprising one beacon for each of the BSSs, and code for causing the access point to transmit pending multicast data for a first BSS of the plurality of BSSs following the first sequence of beacons. The code for causing the access point to transmit pending multicast data the scheduler may also include code for transmitting pending multicast data for the BSSs following the first sequence of beacons. In one aspect, the instruction may also include code for causing the access point to transmit a second uninterrupted sequence of beacons comprising one beacon for each of the BSSs and code for causing the access point to transmit pending multicast data for a second BSS of the plurality of BSSs following the second sequence of beacons.

In another aspect, the code for causing the access point to transmit the first uninterrupted sequence of beacons may be code for transmitting a beacon including a delivery traffic indication map (DTIM) information element to signal whether pending multicast data will be transmitted to a BSS associated with the beacon following the first sequence of beacons.

In another aspect, the code for causing the access point to transmit pending multicast data may be configured to transmit pending multicast data in an order determined using a round robin schedule or using a weighted schedule.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 depicts a wireless communication system, according to one embodiment of the invention;

FIG. 2 schematically depicts a pattern of beacon and multicast traffic transmission involving multiple BSSs representing a conventional approach;

FIG. 3 schematically depicts a pattern of beacon and multicast traffic transmission involving multiple BSSs, according to one embodiment of the invention;

FIG. 4 schematically depicts another pattern of beacon and multicast traffic transmission involving multiple BSSs, according to one embodiment of the invention;

FIG. 5 depicts an access point configured to support multiple BSSs, according to one embodiment of the invention;

FIG. 6 depicts a flow chart showing a routine for delivering pending multicast data, according to one embodiment of the invention; and

FIG. 7 depicts a flow chart showing another routine for delivering pending multicast data, according to one embodiment of the invention

### DETAILED DESCRIPTION OF THE INVENTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For purposes of convenience and clarity only, directional terms, such as top, bottom, left, right, up, down, over, above, below, beneath, rear, back, and front, may be used with respect to the accompanying drawings or particular embodiments. These and similar directional terms should not be construed to limit the scope of the invention in any manner and may change depending upon context. Further, sequential terms such as first and second may be used to distinguish similar elements, but may be used in other orders or may change also depending upon context.

Further, embodiments are discussed in specific reference to wireless networks. As such, this disclosure is applicable to any suitable wireless communication systems having the necessary characteristics. Although discussed in specific reference to an infrastructure WLAN, the techniques of this disclosure may be applied to other network configurations or to other wireless communication systems involving periodic beacon transmissions for coordinating delivery of traffic to client devices. Further, the access point functionality involving such beacon transmissions may be embedded in other devices of an information handling system such as, for example, routers, switches, servers, computers, or the like, and the designation as an access point is not limited to dedicated access point devices.

Unless defined otherwise, all technical and scientific terms used herein have the same meaning as commonly understood by one having ordinary skill in the art to which the disclosure pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

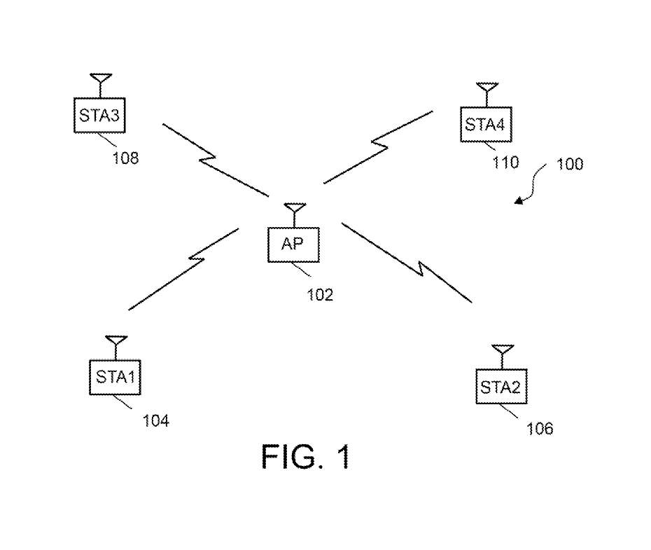

To help illustrate aspects of this disclosure, an exemplary communication system 100 featuring multiple BSSs is schematically depicted in FIG. 1. As shown, access point (AP) 102 may support multiple BSSs, such that AP 102 and a first station (STA1) 104 are members of BSS1, AP 102 and second station (STA2) 106 are members of BSS2, AP 102 and a third station (STA3) 108 are members of BSS3 and AP 102 and a fourth station (STA4) 110 are members of BSS4. Communication system 100 is depicted as a simplified example to provide a context for describing aspects of this disclosure. As such, each BSS may include other participating devices, but they are not illustrated for the sake of clarity. Further, although four BSSs are depicted, these techniques may be applied to any number of BSSs greater than one as desired.

Traffic between AP 102 and any associated stations in a BSS may be characterized as unicast, multicast or broadcast. Unicast traffic includes frames addressed to a single station within a BSS, while multicast traffic includes frames addressed to a plurality of stations within a BSS and broadcast traffic includes frames addressed to all stations within a BSS. For the purposes of this invention, broadcast frames may be considered to constitute a specific type of multicast traffic. Correspondingly, as used herein, the term “multicast” includes either multicast or broadcast data unless otherwise designated.

During operation, AP 102 may be configured to provide the management functions necessary to support each BSS, including the transmission of periodic transmissions beacons. These beacons may contain timing synchronization information to help coordinate scheduled activities among the participating devices as well as other important network parameters, capabilities, rates and the like. One important function provided by the beacon relates to the implementation of power management strategies by the associated stations. For example, a subset of beacons may include an information element known as a delivery traffic indication map (DTIM) to allow AP 102 to signal stations within a given BSS that multicast data has been buffered and will be transmitted following the beacon. Accordingly, each station in the BSS may operate in a power save mode of operation during periods of time leading up to the transmission of a beacon containing a DTIM. The stations may transition to an active mode to receive the beacon and therefore determine whether any data is pending transmission. If so, the stations may remain in the active mode to receive the subsequent transfer of the buffered data. Otherwise, when the DTIM indicates that no data is pending, the stations may immediately return to the power save mode upon receipt of the beacon to conserve resources.

Therefore, in its management role of supporting multiple BSSs, AP 102 may periodically transmit beacons for each BSS. Since it is generally not feasible to transmit beacons simultaneously, the timing of such beacon transmissions for each BSS may be coordinated at AP 102. One conventional strategy, known as “staggered” beaconing, involves spreading the beacon transmissions out in the time domain, with a separate target beacon transmission time (TBTT) for each BSS. A drawback to this approach is that it may require generation of an interrupt for each beacon transmission in order to suspend any ongoing activities and allow the beacon to be sent at the appropriate time. Since an interrupt may be required for each BSS, overall performance may be reduced. An alternative to staggered beaconing is known as “bursted” beaconing, such that beacons for all BSSs are sent sequentially at a single TBTT. Under this scheme, a single interrupt may be generated to trigger the sending of beacons for all BSSs.

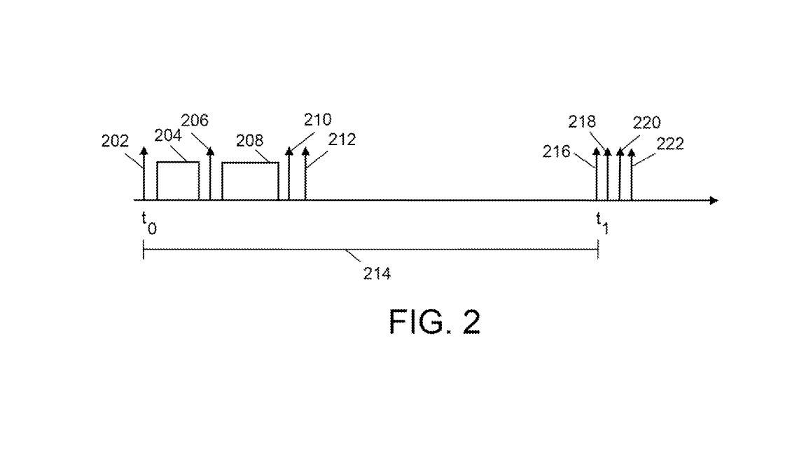

An example of a conventional bursted beaconing pattern as applied to communication system 100 is depicted in FIG. 2. As indicated, AP 102 may be configured to transmit the beacons containing the DTIM for each BSS and then any pending multicast data for that BSS sequentially, commencing at a first time, t₀. Specifically, AP 102 transmits beacon 202 containing the DTIM for BSS1 followed by multicast frames 204 designated for stations associated with BSS1, such as STA1 104. Immediately following multicast frames 204, AP 102 transmits beacon 206 containing the DTIM for BSS2 and then multicast frames 208 addressed to stations in BSS2, such as STA2 106. Following multicast frames 208, AP 102 may then send beacons 210 and 212 for BSS3 and BSS4, respectively. In the depicted example, no multicast traffic is pending for BSS3 or BSS4. Subsequently, after a period of time measured from t₀ known as the DTIM interval 214, AP 102 may repeat the pattern with another burst of beacon transmission, including beacon 216 for BSS1, beacon 218 for BSS2, beacon 220 for BSS3 and beacon 222 for BSS4, with any multicast data interleaved between the beacons, although no multicast data is shown in this simplified example.

The conventional beaconing pattern indicated in FIG. 2 involves the generation of single interrupts at times t₀ and t₁, which represents a reduction with respect to staggered beaconing strategies. However, a consequence of this pattern is that the stations involved experience varying timing and correspondingly unequal opportunities to enter power save mode. For example, stations in BSS1 (such as STA1 104 in FIG. 1) may be seen to receive beacon 202 and then multicast frames 204, after which such stations may return to power save mode. Conversely, stations in BSS2 (such as STA2 106) must wait through the transmission of multicast frames 204 before receiving beacon 206 and multicast frames 208. Worse, stations in BSS3 and BSS4, such as STA3 108 and STA4 110 may remain active until beacons 210 and 212 are received, indicating that no multicast traffic is pending for these BSSs. Thus, as this example demonstrates, STA3 108 and STA4 110 remain awake for the periods of time associated with the transmission of multicast frames for the other BSSs before determining that they are able to return to power save mode. The time required to transmit multicast frames may vary, depending upon the amount of associated data, and may represent a substantial amount of time. Accordingly, any station not in BSS1 experiences a relative delay in receiving beacons and, potentially, multicast frames. Further, the relative delay may increase for stations associated with BSSs having beacons sent later in the sequence when intervening BSSs have pending multicast traffic.

Therefore, it may be desirable for the stations in each BSS to be able to more quickly determine whether any relevant data is pending and, as a result, increase the amount of time spent operating in power save mode. Likewise, it may also be desirable to reduce the amount of time between a beacon containing a DTIM and the transmission of the corresponding buffered data, again resulting in an increase in the amount of time the station may spend in the power save mode. To achieve these benefits, the systems and methods of this disclosure describe an access point, such as AP 102, that may be configured to transmit an uninterrupted sequence of beacons for each of the BSSs that the AP supports, followed by one or more groups of multicast frames. In one aspect, AP 102 may be configured to send multicast frames for each of the BSSs after the sequence of beacons. In another aspect, AP 102 may be configured to send multicast frames for one of the BSSs after a first sequence of beacons and to send multicast frames for other BSSs after subsequent sequences of beacons.

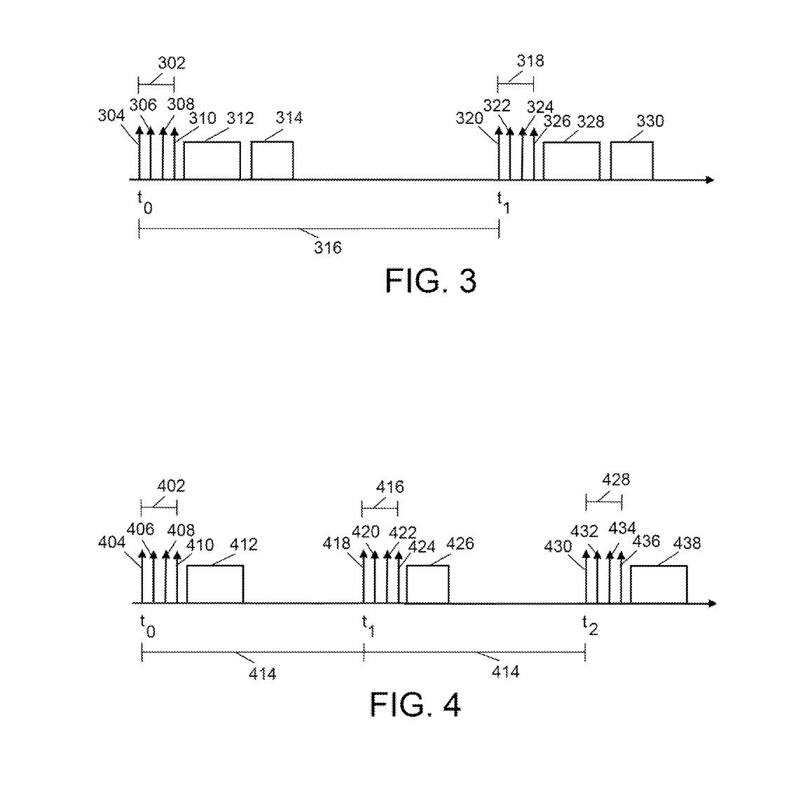

As such, one embodiment of the disclosure is schematically depicted in FIG. 3. In the first bursted beaconing pattern, AP 102 may be configured to transmit uninterrupted sequences of beacons, followed by any pending multicast traffic. For example, AP 102 may be configured to transmit sequence 302 of DTIM beacons at time t₀, including beacon 304 for BSS1, beacon 306 for BSS2, beacon 308 for BSS3 and beacon 310 for BSS4. Following sequence 302, AP 102 may be configured to transmit pending multicast traffic for each of the BSSs. For example, AP 102 transmits multicast frames 312 for stations in BSS1 (such as STA1 104) and then multicast frames 314 for stations in BSS3 (such as STA3 108). In this example, AP 102 has no pending multicast traffic for BSS2 or BSS4 at t₀. Following DTIM interval 316, AP 102 then may transmit another sequence 318 of beacons at time t₁, including beacon 320 for BSS1, beacon 322 for BSS2, beacon 324 for BSS3 and beacon 326 for BSS4. After transmission of sequence 318, AP 102 may transmit multicast data that has been buffered subsequent to t₀. In the depicted example, there is multicast data for BSS2 and BSS4, as indicated by multicast frames 328 and multicast frames 330, respectively. In one embodiment, following a sequence of DTIM beacons, AP 102 may then sequentially transmit multicast traffic for all of the BSSs that have been buffered in the preceding DTIM interval.

By grouping the DTIM beacons into uninterrupted sequences, stations in each BSS may be provided with a more balanced opportunity to enter power save mode. In particular, all stations for all BSSs may be able to determine whether multicast data is pending by the time a given sequence of beacons is transmitted, without any delays associated with the transmission of multicast frames. For example, following transmission of sequence 302, stations in BSS2, such as STA2 106, and stations in BSS4, such as STA4 110, may determine from the DTIM that no multicast traffic is pending for their BSSs and immediately return to power save mode, if desired, without waiting for the transmission of multicast frames 312 or multicast frames 314. Likewise, after transmission of sequence 318, stations in BSS1, such as STA1 104, and stations in BSS3, such as STA3 108, may enter power save mode without waiting for transmission of multicast frames 328 or multicast frames 330.

Although the above example has been described as maintaining a consistent order in the delivery of multicast frames for the BSSs, it may be desirable to rotate or otherwise select the order of BSSs in scheduling delivery of the multicast traffic. Any suitable scheduling mechanism may be employed to coordinate the order in which frames for the separate BSSs are sent. For example, a round-robin policy may be employed. Alternatively, a weighted scheduling may be used based on factors such as number of frames pending or the quality of service (QoS) associated with the pending frames.

In another embodiment of the disclosure, a second bursted beaconing pattern may be employed to reduce the amount of time between transmission of the DTIM beacon for a given BSS and the corresponding multicast traffic to increase the amount of time a station may operate in power save mode. The second bursted beaconing pattern may include transmitting multicast frames for one of the BSSs following a given sequence of beacons and deferring transmission of multicast frames for other BSSs to subsequent sequences of beacons. This pattern is depicted in FIG. 4, which shows the transmission of sequence 402 of DTIM beacons at time t₀, including beacon 404 for BSS1, beacon 406 for BSS2, beacon 408 for BSS3 and beacon 410 for BSS4. In this embodiment, AP 102 is configured to transmit multicast frames for only one of the BSSs after a sequence of beacons. Accordingly, the beacons in sequence 402 may be configured to indicate multicast traffic for BSS1 and defer multicast traffic for BSS2, BSS3 and BSS4 until later beacon sequences. Therefore, following sequence 402, AP 102 may be configured to transmit multicast frames 412 for stations in BSS1, such as STA1 104.

Next, at time t₁ following DTIM interval 414, AP 102 may transmit DTIM beacon sequence 416, including beacon 418 for BSS1, beacon 420 for BSS2, beacon 422 for BSS3 and beacon 424 for BSS4. Here, AP 102 may be configured to transmit multicast traffic for a different BSS having pending data. For example, if no multicast data has arrived for BSS2, but there is multicast data for BSS3 and BSS4, AP 102 may send DTIM beacon sequence 416 indicating multicast traffic for BSS3 and defer the multicast traffic for BSS4 to a later sequence. As indicated, AP 102 may transmit multicast frames 426 for stations in BSS3, such as STA3 108.

The last sequence 428 of DTIM beacons shown in FIG. 4 is then transmitted at time t₂ after DTIM interval 414. Sequence 428 includes beacon 430 for BSS1, beacon 432 for BSS2, beacon 434 for BSS3 and beacon 436 for BSS4. As referenced above, multicast traffic for BSS4 was deferred at time t₀ and time t₁, and may be delivered now, along with any additional multicast data for BSS4 that may have been buffered subsequent to t₁. Accordingly, the DTIM beacons in sequence 428 may indicate that BSS4 has pending multicast traffic while data for all other BSSs may be deferred and their respective beacons may have DTIMs that indicate no buffered data will be transmitted following the beacon. AP 102 then transmits multicast frames 438 for stations in BSS4, such as STA4 110.

As described above, any suitable scheduling mechanism may be employed to coordinate the order in which BSSs are served. For example, a round-robin policy may be employed. Alternatively, a weighted scheduling may be used based on factors such as number of frames pending or the quality of service (QoS) associated with the pending frames.

Although the second bursted beaconing pattern is described above as transmitting multicast traffic for a single BSS following a given sequence, benefits associated with minimizing the time between beacon transmission and the transmission of corresponding multicast frames may be realized by scheduling multicast deliveries for a subset of the multiple BSSs following each DTIM beacon sequence. For example, multicast traffic for BSS1 and BSS2 may be sent after a first sequence and multicast traffic for BSS3 and BSS4 may be sent after the subsequent sequence.

By selecting a portion of the pending multicast traffic for delivery after each DTIM beacon sequence such that traffic for a single BSS or a subset of the multiple BSSs is sent and traffic for the other BSSs is deferred, the time between beacon transmission and multicast transmission for a given BSS may be reduced. In the example of FIG. 4, multicast frames 412 for BSS1 are sent immediately following sequence 402, allowing stations in BSS1 to receive the multicast traffic and then return to power save mode without waiting for the transmission of any multicast traffic for other BSSs. Further, as described, the remaining BSSs are not scheduled for delivery at this time, so the DTIMs in sequence 402 indicate no multicast data is pending and any stations in BSS2, BSS3 or BSS4 may return to power save mode without waiting for the transmission of any multicast traffic. Similarly, after sequence 416, stations in BSS3 may immediately receive multicast frames 426 and stations in the other BSSs may immediately return to power save mode without any delays associated with intervening multicast transmissions. In comparison, the bursted beaconing pattern shown in FIG. 3 may result in stations in one BSS remaining in active mode during transmission of multicast traffic for other BSSs before receiving their multicast traffic. For example, following sequence 302, stations in BSS2 may remain in active mode during the transmission of multicast frames 312 for BSS1 before receiving multicast frames 314.

Therefore, the bursted beaconing pattern exemplified by FIG. 4 may provide increased power savings opportunities for each BSS in exchange for the latency associated with deferring multicast traffic. For example, even though multicast traffic is pending for BSS4 at time t₁, it is deferred to time t₂. Such increases in latency may be an acceptable tradeoff in applications where maximizing power savings is important, such as in mobile or other battery-powered applications.

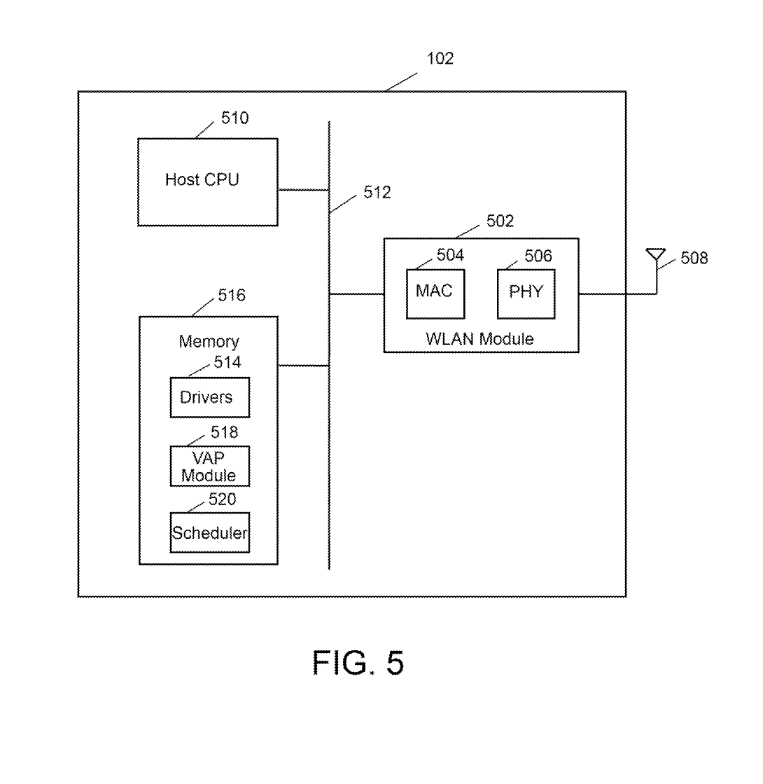

One embodiment of access point 102 is depicted in FIG. 5, showing principle functional blocks in a high level schematic diagram. Generally, access point 102 may employ an architecture in which the lower levels of the WLAN protocol stack are implemented through firmware and hardware in WLAN module 502. WLAN module 502 may therefore include media access controller (MAC) 504 that performs functions related to the handling and processing of frames of data including verification, acknowledgment, routing, formatting and the like. Incoming and outgoing frames are exchanged between MAC 504 and physical layer (PHY) 506, which as shown here includes the functions of modulating the frames according to the relevant 802.11 protocol as well as providing the analog processing and RF conversion necessary to provide transmission and reception of wireless signals through antenna 508.

AP 102 may also include host CPU 510 configured to perform the various computations and operations involved with the functioning of AP 102. Host CPU 510 is coupled to WLAN module 502 through bus 512, which may be implemented as a peripheral component interconnect express (PCIe) bus, a universal serial bus (USB), a universal asynchronous receiver/transmitter (UART) serial bus, a suitable advanced microcontroller bus architecture (AMBA) interface, a serial digital input output (SDIO) bus, or other equivalent interface. Upper layers of the protocol stacks of the WLAN system are generally implemented in software as Drivers 514 stored in memory 516 that may be accessed by host CPU 510 over bus 512.

AP 102 may be configured to support multiple BSSs by implementing a logical virtual access point (VAP) for each BSS. As shown, VAP module 518 may be implemented as processor-readable instructions stored in memory 516 that may be executed by host CPU 510. VAP module 518 may coordinate with MAC 504 to emulate the operations of a physical access point.

Suitable operations associated with the transmission of DTIM beacon sequences and selection of multicast traffic for delivery following each sequence may be implemented by scheduler 520. In one aspect, scheduler 520 may include processor-readable instructions stored in memory 516 that may be executed by host CPU 510. Scheduler 520 may also be implemented using any other desired combination of firmware or hardware.

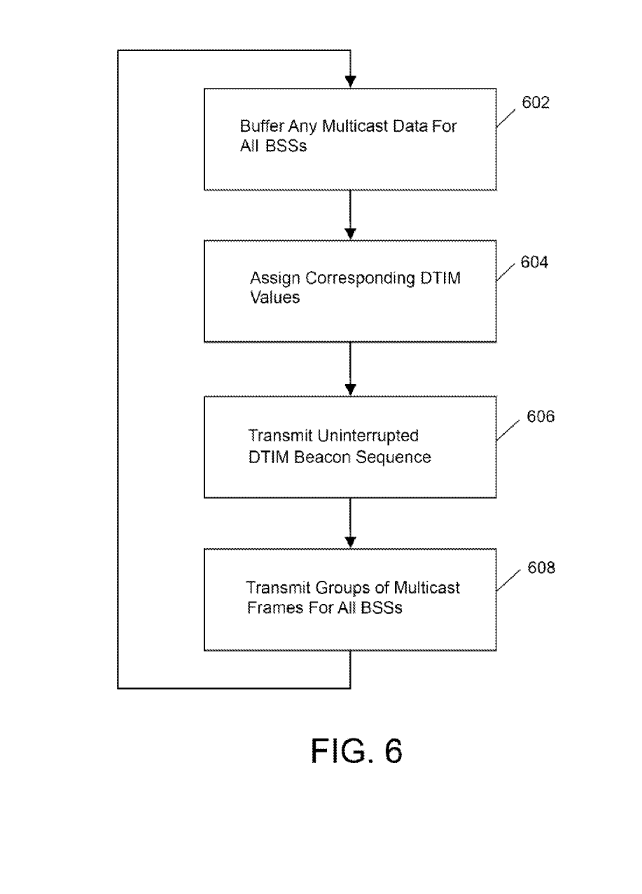

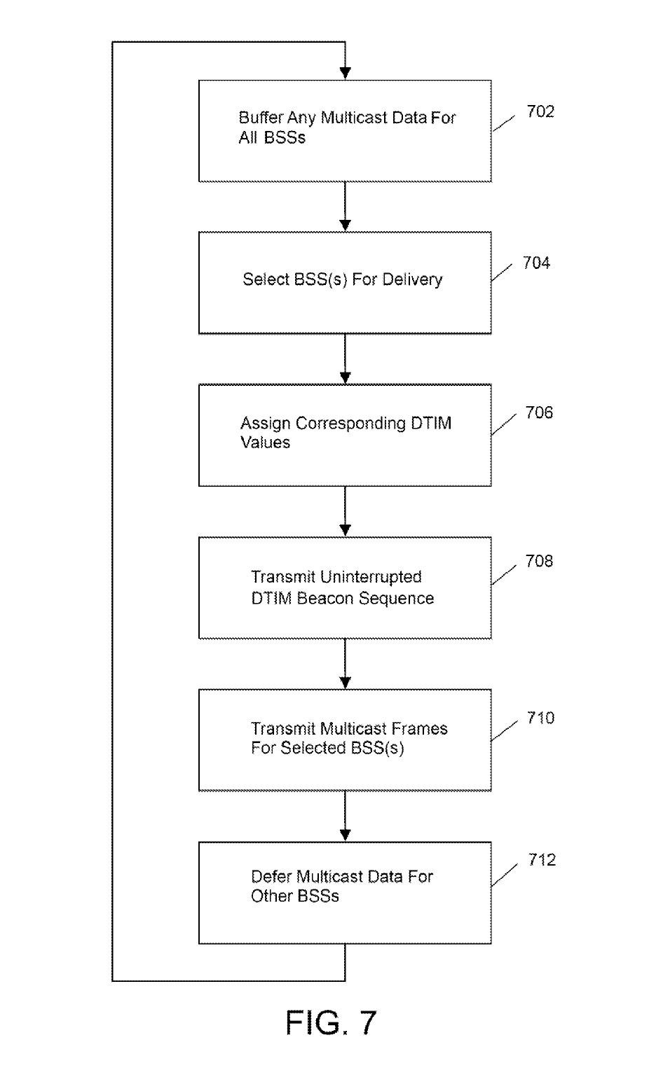

Exemplary routines involving the operation of scheduler 520 are depicted in FIGS. 6 and 7.

The bursted beaconing pattern shown in FIG. 3 may be implemented using the routine shown in FIG. 6. Beginning with step 602, AP 102 receives or generates multicast traffic and buffers the corresponding multicast data for associated stations in each of the multiple BSSs supported by AP 102 over the course of a DTIM interval. Scheduler 520 may then assign appropriate DTIM values corresponding to the presence or absence of pending multicast data for each BSS in step 604. AP 102 transmits an uninterrupted sequence of DTIM beacons at the target beacon transmission time (TBTT) in step 606. Following transmission of the sequence, scheduler 520 may transmit groups of multicast frames for each BSS having pending multicast data in step 608. As described above, the order in which the groups are transmitted may be determined on any suitable basis, depending upon the desired performance characteristics. The routine may then return to step 602 for the next DTIM interval.

Likewise, the bursted beaconing pattern shown in FIG. 4 may be implemented using the routine shown in FIG. 7. Beginning with step 702, AP 102 buffers multicast data for associated stations in each of the multiple BSSs supported by AP 102 over the course of a DTIM interval. In step 704, Scheduler 520 may then select one BSS or a subset of BSSs from the multiple BSSs having pending multicast data for multicast delivery following the next sequence of DTIM beacons. The pending multicast data may include multicast traffic received or generated during the preceding DTIM interval or multicast data that has been deferred, as described below. Again, selection of the BSS(s) for delivery may include a round-robin policy, a weighted scheduling, a rotating order, or any other suitable basis. Accordingly, in step 706 scheduler 520 may assign appropriate DTIM values depending upon the selection of BSS(s). AP 102 transmits an uninterrupted sequence of DTIM beacons at the target beacon transmission time (TBTT) in step 708. Following transmission of the sequence, AP 102 may transmit multicast frames for the selected BSS(s) having pending multicast data in step 710. Any multicast data for other BSSs that were not selected in step 704 may be deferred for later delivery in step 712. The routine may then return to step 702 for the next DTIM interval.

Thus, by employing the techniques of this disclosure, the stations in each BSS may more quickly determine whether any relevant data is pending and accordingly increase the amount of time spent operating in the power save mode. Further, some embodiments may reduce the amount of time between a DTIM beacon and transmission of the corresponding buffered data for stations in a given BSS, allowing such stations to spend a greater proportion of time in power save mode. These techniques may be implemented through operations involving AP 102 and may be transparent with regard to operation of stations, such that conventionally configured stations may still receive the benefits associated with the techniques.

Described herein are presently preferred embodiments. However, one skilled in the art that pertains to the present invention will understand that the principles of this disclosure can be extended easily with appropriate modifications to other applications.

What is claimed is:

1. A method for wireless communication in a system including a plurality of independent basic service sets (BSSs), comprising:
buffering multicast data for the plurality of BSSs;
transmitting a first uninterrupted sequence of beacons comprising one beacon for each of the BSSs; and
transmitting pending multicast data for a first BSS of the plurality of BSSs following the first sequence of beacons.

2. The method of claim 1, further comprising transmitting pending multicast data for the BSSs following the first sequence of beacons.

3. The method of claim 1, further comprising:
transmitting a second uninterrupted sequence of beacons comprising one beacon for each of the BSSs; and
transmitting pending multicast data for a second BSS of the plurality of BSSs following the second sequence of beacons.

4. The method of claim 1, wherein transmitting the first uninterrupted sequence of beacons comprises transmitting a beacon including a delivery traffic indication map (DTIM) information element configured to signal whether pending multicast data will be transmitted to a BSS associated with the beacon following the first sequence of beacons.

5. The method of claim 3, wherein transmitting pending multicast data comprises transmitting pending multicast data in an order determined using a round robin schedule.

6. The method of claim 3, wherein transmitting pending multicast data comprises transmitting pending multicast data in an order determined using a weighted schedule.

7. An access point supporting a plurality of independent basic service sets (BSSs) comprising a wireless local area (WLAN) module configured to transmit a first uninterrupted sequence of beacons comprising one beacon for each of the BSSs and a scheduler configured to transmit pending multicast data for a first BSS of the BSSs following the first sequence of beacons.

8. The access point of claim 7, wherein the scheduler is further configured to transmit pending multicast data for the BSSs following the first sequence of beacons.

9. The access point of claim 7, wherein the scheduler is further configured to transmit a second uninterrupted sequence of beacons comprising one beacon for each of the BSSs and to transmit pending multicast data for a second BSS of the plurality of BSSs following the second sequence of beacons.

10. The access point of claim 7, wherein the first sequence of beacons comprises a beacon including a delivery traffic indication map (DTIM) information element to signal whether pending multicast data will be transmitted to a BSS associated with the beacon following the first sequence of beacons.

11. The access point of claim 9, wherein the scheduler is configured to deliver pending multicast data in an order determined using a round robin schedule.

12. The access point of claim 9, wherein the scheduler is configured to deliver pending multicast data in an order determined using a weighted schedule.

13. A non-transitory processor-readable storage medium for managing communication in a power save mode of a wireless local area network (WLAN) having a plurality of independent basic service sets (BSSs), the processor readable storage medium having instructions thereon, the instructions comprising:
code for causing an access point to buffer multicast data for the plurality of BSSs;
code for causing the access point to transmit a first uninterrupted sequence of beacons comprising one beacon for each of the BSSs; and
code for causing the access point to transmit pending multicast data for a first BSS of the plurality of BSSs following the first sequence of beacons.

14. The non-transitory processor-readable storage medium of claim 13, wherein the code for causing the access point to transmit pending multicast data further comprises code for transmitting pending multicast data for the BSSs following the first sequence of beacons.

15. The non-transitory processor-readable storage medium of claim 13, further comprising code for causing the access point to transmit a second uninterrupted sequence of beacons comprising one beacon for each of the BSSs and code for causing the access point to transmit pending multicast data for a second BSS of the plurality of BSSs following the second sequence of beacons.

16. The non-transitory processor-readable storage medium of claim 13, wherein the code for causing the access point to transmit the first uninterrupted sequence of beacons comprises code for transmitting a beacon including a delivery traffic indication map (DTIM) information element to signal whether pending multicast data will be transmitted to a BSS associated with the beacon following the first sequence of beacons.

17. The non-transitory processor-readable storage medium of claim 15, wherein the code for causing the access point to transmit pending multicast data is configured to transmit pending multicast data in an order determined using a round robin schedule.

18. The non-transitory processor-readable storage medium of claim 15, wherein the code for causing the access point to transmit pending multicast data is configured to transmit pending multicast data in an order determined using a weighted schedule.
